(19) United States
(12) Patent Application Publication
(10) Pub. No.: US 2002/0134954 A1
(43) Pub. Date: Sep. 26, 2002

(54) VALVE FOR CONTROLLING FLUIDS

(76) Inventors: Dieter Kienzler, Leonberg (DE); Stefan Schuerg, Ludwigsburg (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/049,603

(22) PCT Filed: May 23, 2001
(86) PCT No.: PCT/DE01/01960

(30) Foreign Application Priority Data
Jun. 14, 2000 (DE) 100 29 296.8

(51) Int. Cl. F16K 31/12

(52) U.S. Cl. 251/57

(57) ABSTRACT

The present invention relates to a valve for controlling fluids, having a piezoelectric actuator and a hydraulic booster (2), which has a first piston (3), a second piston (4), and a pressure chamber (6) disposed between the two pistons. A valve member (6) is connected to the second piston (4) and can be brought into contact with at least a first valve seat (7). To adjust a stroke of the valve member (6), a separate adjusting element (10) is present as an individual component.

### PRIOR ART

The present invention relates to a valve for controlling fluids as generically defined by the preamble to claim 1.

Various versions of valves for controlling fluids are known. For example, FIG. 3 shows a valve 1 for controlling fluids, which has a hydraulic booster 2 that has a first piston 3, a second piston 4, and a pressure chamber 5 disposed between the two pistons 3, 4. The first piston 3 can be actuated via an actuating piston by means of a piezoelectric element (not shown). The second piston 4 is connected to a valve member 6 via a tappet 11. The valve member 6 is pressed against a first valve seat 7 by means of a leaf spring 9. Upon an actuation of the piezoelectric actuator, the valve member 6 is lifted from the first valve seat 7 via the hydraulic booster 2 and the tappet 11, and as a result a pressure increase in an injection region of a valve needle is furnished, in order to lift the needle from an injection opening and to inject fuel into a combustion chamber (not shown). As shown in FIG. 3, the above-described elements of the valve are disposed in a holder 16, a valve piece 17, and a shim 18. The shim 18 has both a throttle device 14 and a second valve seat 8, on which the valve member 6 rests via the leaf spring 9.

To furnish a reliable function of the valve, the positional fixation between the first valve seat 7 and the second valve seat 8 must in particular be embodied quite precisely. To that end, the valve piece 17 and the shim 18 are joined together by means of alignment pins. The stroke of the valve is adjusted via the diameter of the balls. Since because of production variations slight deviations occur in the position of the first valve seat 7 relative to the second valve seat 8, valve members with different diameters must be made available. Since the valve stroke is in general only 50 μm long, a relatively large number of balls of different diameters, with stringent tolerances, have to be kept on hand. A stepped through bore in the valve piece 17 is also necessary, in order to receive the individual elements of the valve, that is, the second piston 4, the tappet 11, and the valve member 6. Hence a plurality of work steps are necessary in order to produce the stepped bore, which makes the production of the valve complicated and expensive.

### ADVANTAGES OF THE INVENTION

The valve according to the invention for controlling fluids, as defined by the characteristics of claim 1, has the advantage over the prior art that it has a separate adjusting element for adjusting the stroke of the valve. This makes it possible to provide a through bore of a constant diameter on the valve piece and thus to dispense with the complicated stepped bore of the prior art. Since the valve stroke is adjusted via a separate adjusting element, the seat diameter of the valve always remains constant. Hence valve balls of different diameters no longer need to be kept available in order to adjust the valve stroke, since the same valve ball can be used in every valve. According to the invention, the valve stroke is adjusted by the separate adjusting element. Because of the constant seat diameter of the valve member at the valve seat, the adjustment of the valve stroke is also simplified markedly. In particular, the valve of the invention can therefore be produced markedly more economically.

Preferably, the separate adjusting element is embodied as an adjusting ring. This makes an especially simple, economical design possible. The valve stroke is adjusted by means of the height of the adjusting ring in the direction of the valve axis.

To furnish a simple design, the valve of the invention has a separate ring, on which the first valve seat is disposed.

Preferably, a second piston, the separate ring and the valve member are disposed jointly in the valve piece, in a through bore of constant diameter. Thus the aforementioned individual parts can be disposed in the valve piece of the valve, and all that is necessary in the valve piece is a bore of constant diameter, which is simple to produce.

Preferably, a separate positioning element is also provided. The positioning element preferably serves to position the separate adjusting element in the bore of the valve piece.

Especially preferably, the separate positioning element has a second valve seat. As a result, it is possible to dispense with a shim in the valve and thus to reduce the number of parts of the valve.

To restore the valve member to a defined outset position again after each actuation, a restoring element is preferably provided, in particular a helical spring, cup spring, or leaf spring. Because of the simple embodiment of the through bore, it is possible in particular have the restoring element engage either the second piston or the valve member. This offers additional degrees of freedom in designing the valve, and depending on the intended use, the valve can be embodied to suit.

Preferably, the valve member is embodied in the form of a ball, a hemisphere, or essentially a mushroom shape. According to the invention, this assures that the ball or hemisphere of the valve member need have only a single diameter, so that in particular the costs for keeping different valve members of different diameters in inventory can be eliminated.

To enable simple, fast assembly, the connection between the separate ring and the bore of the valve piece, and/or the connection between the positioning element and the bore, can preferably be embodied as a press fit. It is thus possible to dispense with such additional assembly steps as applying glue or connecting by means of screws.

### DRAWING

Two exemplary embodiments of the invention are shown in the drawing and will be explained in further detail in the ensuing description. Shown are:

FIG. 1, a valve for controlling fluids in a first exemplary embodiment of the present invention;

FIG. 2, a valve for controlling fluids in a second exemplary embodiment of the present invention; and

FIG. 3, a valve for controlling fluids in accordance with the prior art.

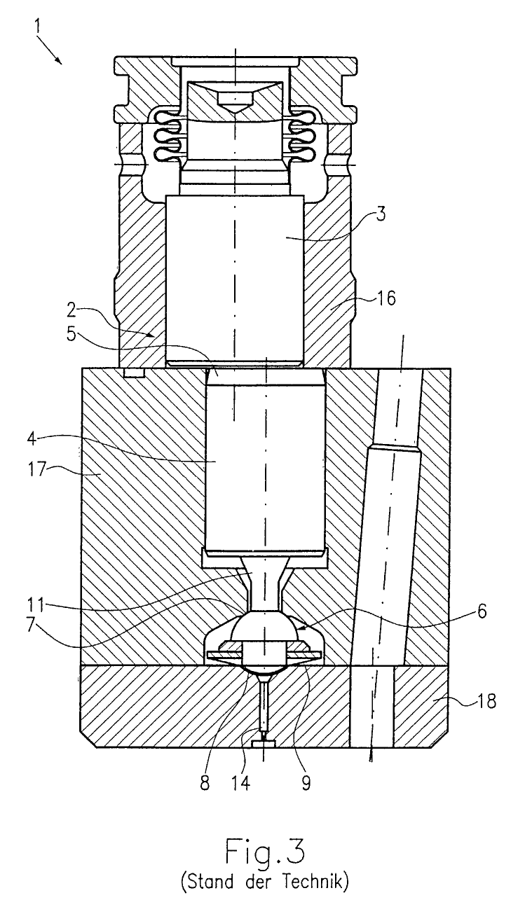

### DESCRIPTION OF THE EXEMPLARY EMBODIMENTS

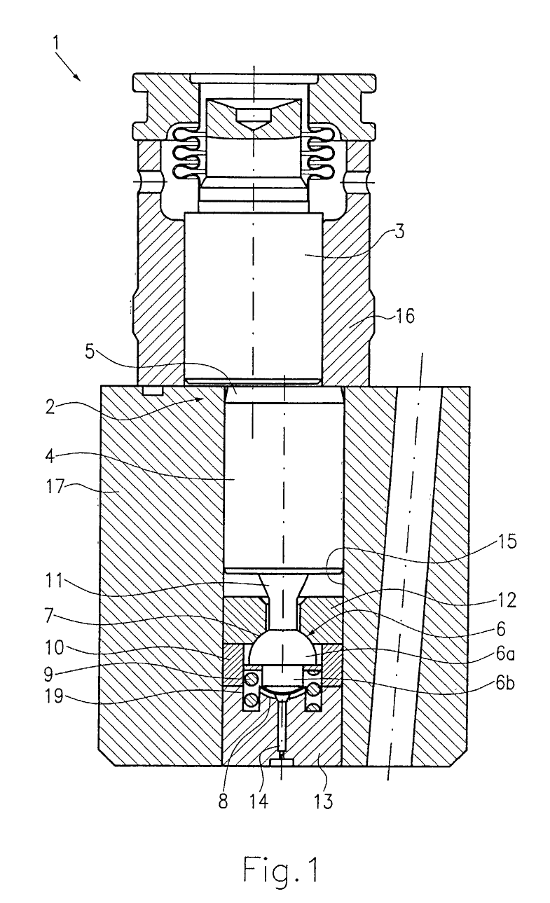

FIG. 1 shows a first valve 1 according to the invention for controlling fluids, which is used as a fuel injection valve. The valve 1 includes a holder 16, a valve piece 17, and a nozzle body (not shown), which are joined together, for instance via a nozzle lock nut. The valve 1 further includes a hydraulic booster 2, which has a first piston 3, a second piston 4, and a pressure chamber 5 disposed between the two pistons 3, 4. The first piston 3 is actuated via a piezoelectric element (not shown), which is disposed in the axial direction of the piston 3, on the side remote from the pressure chamber 5.

The valve of the invention further has a valve member 6. As shown in FIG. 1, the valve member 6 is embodied essentially in the shape of a mushroom and is formed by a hemisphere 6a and a cylindrical extension 6b. The cylindrical extension 6b has a smaller diameter than the hemisphere 6a and has a spherical portion on its end. The valve member 6 rests with the hemisphere 6a in a first valve seat 7. The first valve seat 7 is formed on a ring 12 that is disposed between the valve member 6 and the second piston 4. The second piston 4 is connected to the valve member 6 via a tappet 11 and upon actuation via the piezoelectric actuator lifts the valve member 6 from the first valve seat 7. The ring 12 has a through bore, through which the tappet 11 is guided.

As shown in FIG. 1, a through bore 15 of constant diameter is formed in the valve piece 17. The ring 12 is positioned in the through bore 15 by means of a press fit. A positioning element 13 is also disposed in the bore 15; it has a throttle device 14 and a second valve seat 8. The positioning element 13 is likewise introduced into the bore 15 by means of a press fit. With the ball-shaped end portion of the cylindrical extension 6b, the valve member 6 can be brought into contact with the second valve seat 8.

To enable an exact positional fixation of the first and second valve seats 7, 8, an adjusting ring 10 is disposed between the ring 12 and the positioning element 13. This adjusting ring 10 has a low tolerance, in particular in the axial direction of the valve, so that it furnishes an exact positional fixation of the two valve seats 7, 8 relative to one another.

A spring element 9 embodied as a helical spring is also provided; it is retained in a spring seat 19 in the positioning element 13. The spring element 9 furnishes a restoring device for the valve member 6, and this valve member in its outset state thus rests on the first valve seat 7. However, it is also possible for the spring element to be embodied and disposed such that the valve member 6 in its outset position rests on the second valve seat 8 or is lifted from both valve seats in its outset position.

In the exemplary embodiment shown in FIG. 1, the two valve seats 7, 8 are accordingly provided on separate components that are introduced into the bore 15 of the valve piece 17 simply by means of a press fit. This accordingly makes it possible to embody the bore 15 as a simple through bore of constant diameter, and already to provide the valve seats on the respective components 12, 13 in advance. The height of the valve stroke can also be adjusted simply by means of the height of the adjusting ring 10. This also assures that the valve member 6 always contacts the same valve or seat diameter on the valve seat.

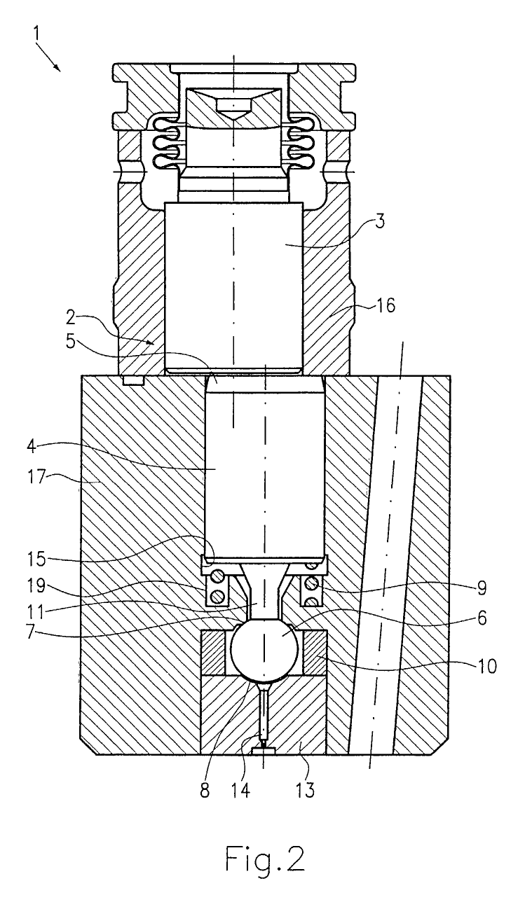

In FIG. 2, a second exemplary embodiment of the present invention is shown. Elements that are the same or similar are identified by the same reference numerals as in the first exemplary embodiment. Since in the second exemplary embodiment, the second valve is essentially equivalent to the valve of the first exemplary embodiment, similar parts will not be described in detail below; instead, the differences between the two valves will be described in particular.

As shown in FIG. 2, the valve 1 of the second exemplary embodiment likewise includes a hydraulic booster 2, which has a first piston 3, a second piston 4, and a pressure chamber 5 disposed between them. The first piston 3 of the hydraulic booster is disposed in a holder 6, and the second piston 4 is disposed in a valve piece 17.

In a distinction from the first exemplary embodiment, in the second exemplary embodiment a stepped through bore 15 is provided in the valve piece 17. As a result, a first valve seat 7 is formed at a region of the through bore 15 that has a small diameter. A simply embodied valve ball 6 is provided as the valve member.

As in the first exemplary embodiment, a second valve seat 8 is embodied on a positioning element 13. The positioning element 13 is secured in the bore 15 by means of a press fit. To assure the positional fixation between the first and second valve seats 7, 8, an adjusting ring 10 is disposed between the two valve seats. Depending on the height of the adjusting ring 10 in the axial direction of the valve, the valve has a corresponding valve stroke of the valve member 6.

In contrast to the first exemplary embodiment, in the second exemplary embodiment the valve member 6 is not in direct contact with the spring element 9. As shown in FIG. 2, a spring seat 19 in the valve piece 17 is formed in such a way that the spring element 9 presses against the second piston 4 of the hydraulic booster 2. In particular, this makes it possible to provide a different outset position of the valve member, and there is no need to provide a spring seat on the valve member.

In summary, the present invention relates to a valve for controlling fluids with a piezoelectric actuator and a hydraulic booster 2, the latter having a first piston 3, a second piston 4, and a pressure chamber 5 disposed between the two pistons. A valve member 6 is connected to the second piston 4 and can be brought into contact with at least one first valve seat 7. To adjust a stroke of the valve member 6, a separate adjusting element 10 is present in the form of an individual component.

The above description of the exemplary embodiments of the present invention is intended solely for purposes of illustration and not for the sake of limiting the invention. Within the scope of the invention, various changes in modifications are possible without departing from the scope of the invention or its equivalents.

1. A valve for controlling fluids, including a piezoelectric actuator, a hydraulic booster (2) which has a first piston (3), a second piston (4), and a pressure chamber (5) disposed between the pistons (3, 4), and a valve member (6), which is connected to the second piston (4) and can be brought into contact with at least a first valve seat (7), characterized in that the valve has a separate adjusting element (10) in order to adjust the stroke of the valve member (6).

2. The valve for controlling fluids of claim 1, characterized in that the separate adjusting element (10) is embodied as an adjusting ring.

3. The valve for controlling fluids of claim 1 or 2, characterized by a separate ring (12), which has the first valve seat (7).

4. The valve for controlling fluids of claim 3, characterized in that the second piston (4), the separate ring (12), and the valve member (6) are disposed jointly in a bore (15) of constant diameter.

5. The valve for controlling fluids of one of claims 1-4, characterized in that the valve has a separate positioning element (13).

6. The valve for controlling fluids of claim 5, characterized in that the positioning element (13) has a second valve seat (8).

7. The valve for controlling fluids of one of claims 1-6, characterized in that the valve also has a restoring element (9), which engages either the second piston (4) or the valve member (6).

8. The valve for controlling fluids of one of claims 1-7, characterized in that the valve member (6) is embodied in the form of a ball, a hemisphere, or essentially a mushroom shape.

9. The valve for controlling fluids of one of claims 3-8, characterized in that a press fit is embodied between the ring (12) and-the-bore (15) and/or between the positioning element (13) and the bore (15).
